(19) United States
(12) Patent Application Publication
(10) Pub. No.: US 2014/0358712 A1
(43) Pub. Date: Dec. 4, 2014

(54) SHOPPING GUIDE SYSTEM, SHOPPING GUIDE MANAGEMENT DEVICE AND METHOD

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/290,975

(22) Filed: May 29, 2014

(30) Foreign Application Priority Data
May 31, 2013 (CN) 201310211389X
May 21, 2014 (CN) 2014102142308

(51) Int. Cl. G06Q 30/06

(52) U.S. Cl. CPC G06Q 30/0601
USPC 705/26.1

(57) ABSTRACT

A shopping guide method includes steps: transmitting a shopping guide information to a portable device in response to a request from the portable device produced by scanning an application scan code which includes an identification code (ID) of a salesperson; and associating a current purchase record of the consumer with the ID of the salesperson when the consumer makes an online purchase via the shopping guide information.

### FIELD

The present disclosure relates to guide systems, and particularly to a shopping guide system, a shopping guide management device, and a method thereof.

### BACKGROUND

Nowadays, in order to enhance awareness of a product, the seller of the product usually advertises the product in a number of ways. A type of advertisement is to deliver leaflet via salesperson. However, such a way of advertisement usually does not achieve a good effect.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure.

Moreover, in the drawings, like reference numerals designate corresponding parts throughout the views.

FIG. 1 is a block diagram of an embodiment of a shopping guide management device.

FIG. 2 is a diagram of a guiding interface.

FIG. 3 is a flowchart diagram of an embodiment of a shopping guide method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

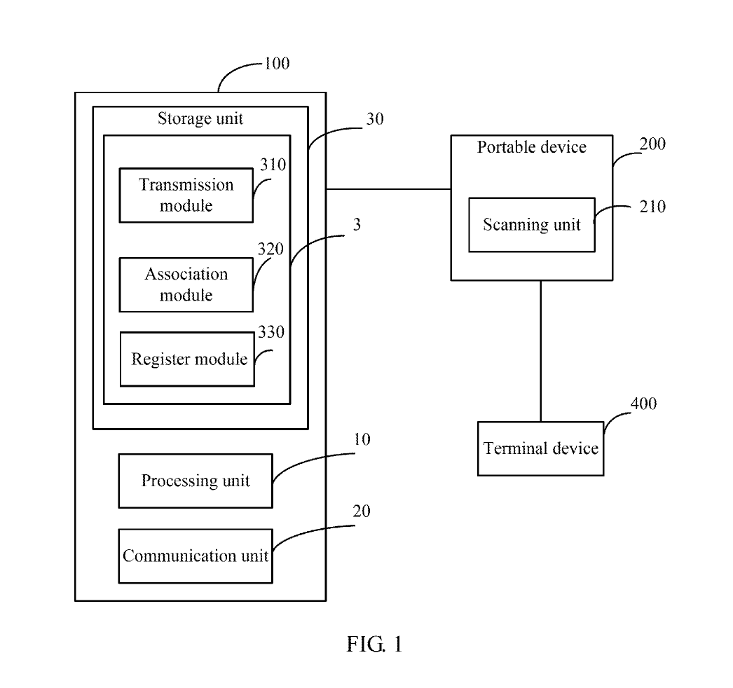

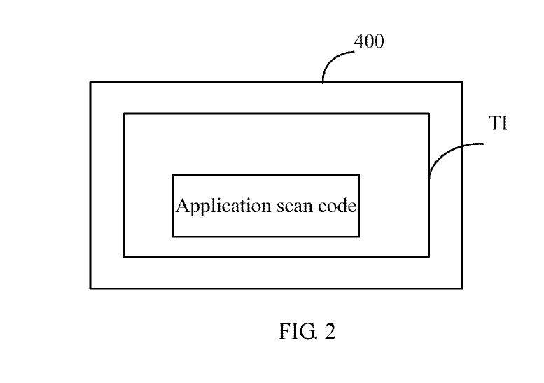

FIGS. 1-2 illustrate a shopping guide management device 100 can include a processing unit 10, a communication unit 20, and a storage unit 30. In the embodiment, the shopping guide management device 100 can be a cloud server.

The communication unit 20 is used to communicate with at least one portable device 200, such as a mobile phone, or a tablet computer of a consumer.

The storage unit 30 stores a shopping guide system 3. The shopping guide system 3 can include a number of modules, which are a collection of software instructions and are executed by the processing unit 10 of the device 100. The modules include a transmission module 310, and an association module 320. In the embodiment, the storage unit 30 can be a hard disk, a compact disk, a flash memory, for example. The processing unit 10 can be a central processing unit, a digital signal processor, or a single chip.

The transmission module 310 can transmit a shopping guide information to the portable device 200 via the communication unit 20 in response to a request of the portable device 200. In the embodiment, the portable device 200 includes a scanning unit 210, the portable device 200 produces the request in response to a user operation of scanning an application scan code corresponding to the shopping guide information by using the scanning unit 210. In the embodiment, the shopping guide information can be a shopping guide application. The application scan code includes an identification code (ID) of a salesperson and can be a two-dimension code or a bar code, the scanning unit 210 can be a scanner or software installed in the portable device 200.

In the embodiment, the application scan code further includes a download address of the shopping guide application, thus the request produced by the portable device 200 also includes the download address of the shopping guide application. The transmission module 310 can obtain the shopping guide application according to the download address of the shopping guide application, and then transmit the shopping guide application to the portable device 200.

For example, FIG. 2 illustrates that a salesperson can provide a guiding interface TI including the application scan code via a terminal device 400. In the embodiment, the application scan code including the ID of the salesperson and the download address of the shopping guide application can be stored in the terminal device 400, and can be displayed on the terminal device 400 in response to an operation of the salesperson, then the consumer can scan the application scan code displayed on the terminal device 400 of the salesperson. In another embodiment, the terminal device 400 can only store the ID of the salesperson and the download address of the shopping guide application, and the application scan code can be produced according to the ID of the salesperson and the download address of the shopping guide application when the salesperson executes share operation. The share operation can be an operation of operating a menu item or a particular button. Therefore, the terminal device 400 can display the application scan code including the ID of the corresponding salesperson. In further embodiment, the application scan code can be printed on paper or cloth attached on the clothing of the salesperson.

The association module 320 is used to associate a current purchase record of the consumer with the ID of the salesperson when the consumer makes an online purchase via the shopping guide application.

In the embodiment, the shopping guide system 3 further includes a register module 330, the register module 330 is used to obtain an account input by the consumer. In the embodiment, the register module 330 obtains the account when the consumer requests to register in the shopping guide application. In another embodiment, the register module 330 obtains the account when the consumer logins the shopping guide application via the account. The consumer can make the online purchase via the shopping guide application after logging in the shopping guide application.

In the embodiment, the consumer can install the shopping guide application on the portable device 200 when receiving the shopping guide application transmitted by the transmission module 310. The consumer then can input the registered account via an input interface (not shown) provided by the installed shopping guide application via the portable device 200, and then the registered account can be transmitted to the register module 330 via the portable device.

In the embodiment, the association module 320 further associates the account of the consumer with the ID of the salesperson when the consumer makes the online purchase. Therefore, it is easily to obtain a relationship between the salesperson and the consumer, namely, which consumer makes the online purchase can be obtained. In another embodiment, the association module 320 further associates purchase records with the ID of the salesperson after associating the account of the consumer with the ID of the salesperson.

In the embodiment, the association module 320 associates the purchase record of the consumer with the ID of the salesperson when the consumer makes a first online purchase via the shopping guide application. In another embodiment, after the consumer is registered in the shopping guide application for a predetermined time, such as, 1 hour after registering, the association module 320 associates a purchase record of the consumer with the ID of the salesperson when the consumer makes the online purchase via the shopping guide application.

In the embodiment, the terminal device 400 has communication function and can be taken as an access point (AP). Then the portable device 200 can search the AP and communicate with network, such as internet, or the shopping guide management device 100 via the AP.

In the embodiment, the terminal device 400 further can display product information when the salesperson introduces the corresponding product to the consumers in any place, such as a shop, an avenue, or a park. The product information can include a picture and a brief introduction of the product.

In the embodiment, the terminal device 400 further can display a product scan code, and the consumer can obtain detail information of the product by scanning the product scan code via the portable device 200. In detail, the product scan code includes a website address of a website about the product, the portable device 200 can access to the website about the product via the website address and obtain the detail information of the product.

In a second embodiment, the shopping guide information can be the website address of the website about the product. Accordingly, in the second embodiment, the application scan code includes the ID of the salesperson and the website address of the website about the product, thus the transmission module 310 obtains the website address and transmits the website address to the portable device 20 via the communication unit 20 in response to the request of the portable device 200 produced by scanning the application scan code.

In a second embodiment, the association module 320 associates the purchase record of the consumer with the ID of the salesperson when the consumer makes an online purchase via the website.

The register module 330 obtains an account input by the consumer when the consumer requests to register in the website or when the consumer logins the website via the account. As usually, the consumer can make the online purchase via the website after logging in the website.

In the second embodiment, the association module 320 also associates the account of the consumer with the ID of the salesperson when the consumer makes the online purchase via the website.

Similarly, in the second embodiment, the applicant scan code can be pre-stored in the terminal device 400, or can be produced according to the ID of the salesperson and the website address of the website when the salesperson executes the share operation.

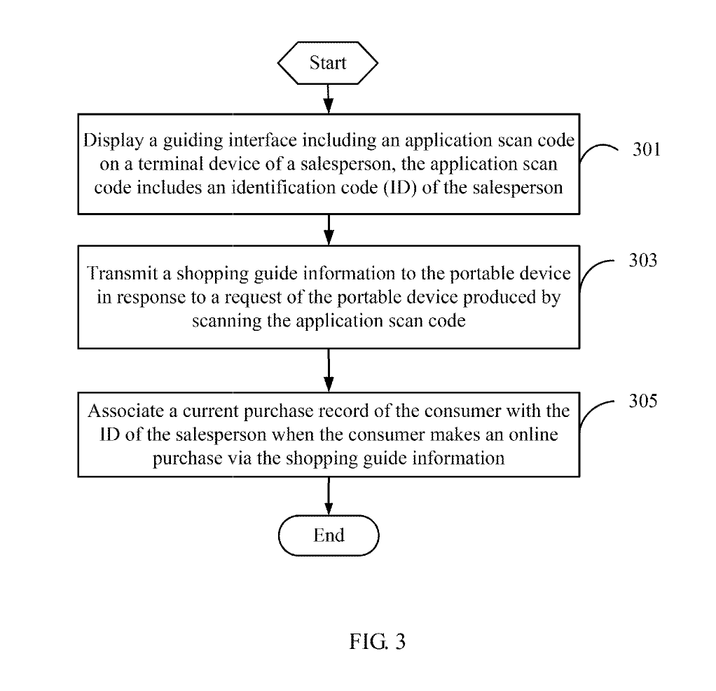

FIG. 3 illustrates a shopping guide method. In 301, the terminal device displays guiding interface including an application scan code. The application scan code can be scanned by the portable device of the consumer and includes an identification code (ID) of the salesperson.

In 303, the transmission module transmits a shopping guide information to the portable device in response to a request of the portable device produced by scanning the application scan code. The shopping guide information can be the shopping guide application or the website address of the website about the product.

In 305, the association module associates a current purchase record of the consumer with the ID of the salesperson when the consumer makes an online purchase via the shopping guide information, such as the shopping guide application or the website.

In the embodiment, the method further includes: the register module obtains an account input by the consumer via the shopping guide application or the website, and associates the account of the consumer with the ID of the salesperson when the consumer makes an online purchase via the shopping guide application or the website.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A shopping guide method comprising:
transmitting a shopping guide information to a portable device in response to a request from the portable device produced by scanning an application scan code which comprises an identification code (ID) of a salesperson; and
associating a current purchase record of the consumer with the ID of the salesperson when the consumer makes an online purchase via the shopping guide information.

2. The method according to claim 1, wherein shopping guide information is a shopping guide application, the step of associating a current purchase record of the consumer with the ID of the salesperson when the consumer makes an online purchase via the shopping guide information comprises:
associating a current purchase record of the consumer with the ID of the salesperson when the consumer makes an online purchase via the shopping guide application.

3. The method according to claim 1, wherein shopping guide information is a website address of a corresponding website, the step of associating a current purchase record of the consumer with the ID of the salesperson when the consumer makes an online purchase via the shopping guide information comprises:
associating a current purchase record of the consumer with the ID of the salesperson when the consumer makes an online purchase via the website.

4. The method according to claim 3, further comprising:
obtaining an account input by the consumer via the website, and
associating the account of the consumer with the ID of the salesperson when the consumer makes the online purchase via the website.

5. A shopping guide system, applied to a shopping guide management device comprising a communication unit for connecting to at least one portable device, the shopping guide system comprising:
a processing unit;
a plurality of modules which are collections of instructions executed by the processing unit, the plurality of modules comprising:
a transmission module configured to transmit a shopping guide information to the portable device via the communication unit when the portable device scans an application scan code comprising an identification code (ID) of a salesperson; and
an association module configured to associate a current purchase record of the consumer with the ID of the salesperson when the consumer makes online purchase via the shopping guide information.

6. The system according to claim 5, wherein the shopping guide information is a shopping guide application, the association module associates a current purchase record of the consumer with the ID of the salesperson when the consumer makes an online purchase via the shopping guide application.

7. The system according to claim 6, wherein the plurality of modules further comprise a register module configured to obtain an account input by the consumer; the association module is further configured to associate the account of the consumer with the ID of the salesperson when the consumer makes the online purchase via the shopping guide application.

8. The system according to claim 5, wherein the shopping guide information is a website address of a corresponding website, the association module associates a current purchase record of the consumer with the ID of the salesperson when the consumer makes an online purchase via the website.

9. The system according to claim 8, wherein the plurality of modules further comprise a register module configured to obtain an account input by the consumer; the association module is further configured to associate the account of the consumer with the ID of the salesperson when the consumer makes the online purchase via the website.

10. The system according to claim 8, wherein the association module associates the purchase record of the consumer with the ID of the salesperson when the consumer makes a first online purchase via the website.

11. The system according to claim 8, wherein the association module associates the purchase record of the consumer with the ID of the salesperson when the consumer makes the online purchase via the shopping guide application, after the consumer is registered in the website for a predetermined time.

12. A shopping guide management device comprising:
a communication unit configured to communicate with at least one portable device; and
a processing unit configured to execute a plurality of modules which are collection of instructions, the plurality of modules comprising:
a transmission module configured to transmit a shopping guide information to the portable device via the communication unit when the portable device scans an application scan code comprising an identification code (ID) of a salesperson; and
an association module configured to associate a current purchase record of the consumer with the ID of the salesperson when the consumer makes online purchase via the shopping guide information.

13. The device according to claim 12, wherein the shopping guide information is a shopping guide application, the association module associates a current purchase record of the consumer with the ID of the salesperson when the consumer makes an online purchase via the shopping guide application.

14. The device according to claim 13, wherein the plurality of modules further comprise a register module configured to obtain an account input by the consumer; the association module is further configured to associate the account of the consumer with the ID of the salesperson when the consumer makes the online purchase via the shopping guide application.

15. The device according to claim 13, wherein the association module associates the purchase record of the consumer with the ID of the salesperson when the consumer makes a first online purchase via the shopping guide application.

16. The device according to claim 13, wherein the association module associates the purchase record of the consumer with the ID of the salesperson when the consumer makes the online purchase via the shopping guide application, after the consumer is registered in the shopping guide application for a predetermined time.

17. The device according to claim 12, wherein the shopping guide information is a website address of a corresponding website, the association module associates a current purchase record of the consumer with the ID of the salesperson when the consumer makes an online purchase via the website.

18. The device according to claim 17, wherein the plurality of modules further comprise a register module configured to obtain an account input by the consumer; the association module is further configured to associate the account of the consumer with the ID of the salesperson when the consumer makes the online purchase via the website.

19. The device according to claim 17, wherein the association module associates the purchase record of the consumer with the ID of the salesperson when the consumer makes a first online purchase via the website.

20. The device according to claim 17, wherein the association module associates the purchase record of the consumer with the ID of the salesperson when the consumer makes the online purchase via the website, after the consumer is registered in the website for a predetermined time.
